(19) United States
(12) Patent Application Publication
(10) Pub. No.: US 2023/0375122 A1
(43) Pub. Date: Nov. 23, 2023

(54) CURING LINERS BY MEANS OF COHERENT ELECTROMAGNETIC RADIATION

(71) Applicant: SAERTEX multiCom GmbH, Saerbeck (DE)

(72) Inventor: Nils FÜCHTJOHANN, Greven (DE)

(21) Appl. No.: 18/247,541

(22) PCT Filed: Sep. 17, 2021
(86) PCT No.: PCT/EP2021/075597

§ 371 Date: Mar. 31, 2023

(30) Foreign Application Priority Data
Oct. 15, 2020 (DE) 10 2020 127 230.8

(51) Int. Cl. F16L 55/165

(52) U.S. Cl. CPC F16L 55/1656

(57) ABSTRACT

The invention relates to a resin system for curing by means of coherent electromagnetic radiation, comprising optical material and at least one initiator, to an uncured liner, a method for curing liners, the use of coherent electromagnetic radiation for curing liners and to a method for curing a resin system.

The invention relates to a resin system suited for curing by means of coherent electromagnetic radiation comprising an optical material and at least one initiator, an uncured liner, a method for curing liners, the use of coherent electromagnetic radiation for curing liners and to a method for curing a resin system.

To date, liners have been cured by means of UV light and/or heat. Up to the present, photocuring has been disadvantageous in that the light is not used very efficiently and much of the emitted quantity of light cannot contribute to curing. The UV light cannot penetrate very deeply into the liner and the deeper liner regions which are further away from the light source may then not be completely cured or the duration of the illumination with UV light must be extended, which results in a significant delay of the curing process. Namely, the irradiated UV light is absorbed by the resin system. Moreover, light with wavelengths at which the curing process is not or not sufficiently started is also irradiated.

WO9851960A1 describes the curing of a liner by means of a laser, wherein a curing agent is encapsulated and the capsules release the curing agent by laser irradiation. The curing agent is not a photoinitiator. The capsules must absorb the laser light. They do not generate their own light radiation.

Thus, the object of the invention is that curing by means of the light sources used to date is inefficient since much of the light intensity does not serve for curing the liner and is lost.

In a first embodiment, the object of the invention is achieved by a resin system suited for curing by means of coherent electromagnetic radiation comprising at least one optical material and at least one (photo)initiator.

In the prior art, the goal has been to select a photoinitiator having an absorption maximum as closely as possible at the wavelength of the irradiating UV light. Now, the inventors have found that a resin system can be cured much more efficiently by using the secondary electromagnetic radiation of optical materials for the activation of the initiator.

Each optical material emits electromagnetic radiation such as, for example, light, when irradiated with electromagnetic radiation such as, for example, light. Usually, most of the radiation is emitted with the wavelength that corresponds to the wavelength of the irradiating radiation. However, radiation with the wavelengths of the so-called overtones or harmonics, that is, light with 1/2, 1/3, 1/4, . . . (that is, the first, second, third, . . . harmonic) of the wavelength of the irradiating radiation is also emitted. The present invention takes advantage of this phenomenon. Usually, UV light does not penetrate very deeply into the cured liner. Hence, currently either a very intense UV light must be used and/or the illumination time must be increased. Both have significant disadvantages (risk of thermal damage of the liner, process time, . . . ). The present invention allows to use an electromagnetic radiation, such as light, having a significantly longer wavelength, such as, for example, infrared light. Then, the optical material ensures that the irradiated light with a long wavelength is emitted by the optical material in the form of overtones with a shorter wavelength, in the UV light range, for example. Then, this UV light is emitted by the optical material with a homogeneous intensity within the complete resin system. Hence, the liner can cure very fast and homogeneously. The method according to the invention allows to cure very thick volumes of a resin system and in particular thick-walled liners fast and with high homogeneity.

Initiators as used according to the present invention are chemical compounds that decompose following the absorption of electromagnetic radiation in a reaction to form reactive species that can start (initiate) a reaction (usually a polymerisation). Usually, the reactive species are free radicals or cations. Preferably, they are photoinitiators.

The electromagnetic radiation in the UV range as used according to the present invention means electromagnetic radiation in the ultraviolet range.

A liner according to the invention is preferably a liner for pipe and canal rehabilitation.

Optical Material

An optical material as used according to the present invention is a dielectric and in particular a material having at least a transmission of 0.0001%, especially preferably 0.1%, particularly preferably at least 15% at the wavelength of the coherent electromagnetic radiation.

For example, optical materials as used according to the present invention comprise classic optical materials such as glass or rutile, for example, that emit 1/3, 1/5, 1/7, . . . of the irradiated wavelength as overtones, but also nonlinear optical materials such as, for example, BaTiO₃, that emit 1/2, 1/3, 1/4, 1/5, . . . of the irradiated wavelength as overtones.

For example, an optical material as used according to the present invention is every material having a certain transmission at the wavelength of the irradiating electromagnetic radiation. When irradiated with light, the material emits light of the so-called harmonics (overtones). The harmonics can have a wavelength of ½, ⅓, ¼, . . . of the wavelength of the irradiating light and a decreasing intensity. Thus, the light colour of the harmonics differs from the colour of the irradiating light. For example, the irradiating radiation penetrates deeply into the volume and has a high intensity even in the light exit area of the liner.

Preferably, the optical material does not heat by the absorption of the radiation and especially by the absorption of the light of a pump laser. Preferably, the optical material does not contribute to the thermal reaction.

For example, the optical material allows to generate wavelengths or frequencies over the entire spectral region in which the material is transmitting. The wavelength of the generated electromagnetic radiation can be adapted to the transmission minimum of the initiator. Hence, numerous initiators may be used.

A mixture of optical materials may also be used. This may serve to generate the same harmonic or to generate different harmonics, for enabling the use of different photoinitiators (thus, for example, pump wavelength: 900 nm; material 1 with ⅓ for an excitation at 300 nm and material 2 with ½ for an excitation at 450 nm). In physics, transmission (from the Latin trans, “through”, and (ap)parere, “appear”) is the ability of matter to transmit electromagnetic waves (transmission). The volume transmission of the optical material at an irradiating wavelength of 800 nm is preferably at least 70%, particularly preferably at least 80%. As is generally known, 100% is the upper limit of transmission. The transmission can be measured with the methods common in the field of canal rehabilitation.

The optical material may be particles or fibres, for example. The optical material may be a powder, conglomerate, crystallite or also a molecule (polymers, . . . ).

Preferably, the optical material is particulate. Preferably, the optical material is nanoparticles. The median particle size of the optical material is preferably in a range from 20 to 1000 nm, especially preferably in a range from 50 to 400 nm, particularly preferably in a range from 150 to 300 nm. The particle size can be measured by laser diffraction or dynamic light scattering, for example.

Usually, the particle size has no effect on the generated wavelength or light colour, however, it affects the intensity of the emitted electromagnetic radiation. The optical material such as, for example, the nanoparticle, can be adjusted to the scattering and/or reflection of the entire material or selected accordingly.

Alternatively preferably, the optical material may be fibres. Particularly preferably, it is glass fibres. Glass fibres are commonly used in liners. For example, the glass fibres can be provided as segments, preferably with a median length in a range from 1 to 20 cm or as longer fibres. In liners, commonly glass fibre mats, non-crimp glass fibre fabrics and/or woven glass clothes are impregnated with resin. The present invention takes advantage of the fact that these glass fibres may be the optically active material, which eliminates the need to use an additional optical material. Preferably, the fibres have a median filament diameter in a range from 200 to 50,000 nm, especially preferably in a range from 5,000 to 24,000 nm. Thus, for example, dielectric components of the bulk material, such as glass fibres (in liners, for example) may be used instead of the nanoparticles or in addition to the nanoparticles. When using dielectric components of the bulk material, such as, for example, glass fibres, no additional optical materials are required, for example. Alternatively or in addition to glass fibres, fibres of polymer, aramid or carbon may also be used. These fibres may also have a preferred filament diameter in a range from 4,000 to 15,000 nm. When using polymer fibres, the filament diameter can be in a range from 10 to 60 μm.

Preferably, the optical material is dielectric, especially preferably dielectrically polar, that is, its crystal structure has a preferred orientation. This allows to use also the second harmonic. Ordinary glass of glass fibres is non-polar. Hence, the second harmonic cannot be used when glass fibres are used. The second harmonic has a significantly higher intensity than the third harmonic.

Hence, the optical material is preferably dielectric nanoparticles and/or dielectric fibres.

Preferably, the coherent electromagnetic radiation is laser light.

Preferably, the wavelength of the coherent electromagnetic radiation is in a wavelength range from 200 to 20000 nm, especially preferably in a wavelength range from 300 to 5000 nm, particularly preferably in a wavelength range from 700 to 2000 nm, most preferably in a range from 800 to 1600 nm.

Preferably, the optical material is contained in the resin system in an amount in a range from 0.01 to 200 parts by weight per 100 parts by weight of resin. If the optical material is particles, the optical material is preferably contained in an amount in a range from 0.01 to 10 parts by weight, especially preferably from 0.02 to 2 parts by weight per 100 parts by weight of resin. If the optical material is fibres, the optical material is preferably contained in an amount in a range from 30 to 150 parts by weight per 100 parts by weight of resin.

The nanoparticle concentration can be varied over a wide range. The nanoparticle concentration can also be very low since the initiation of the reaction by the initiators can take place at a distance within the range of the generated radiation, that is, with a relatively large distance of the nanoparticles. The nanoparticle concentration throughout the resin system can be in a range from 0.01 to 10% by weight, especially preferably in a range from 0.02 to 1% by weight of the resin system, for example.

Preferably, the refractive index of the optical material can be adjusted to the resin system by selecting the optical material. In particular, the refractive index of the optical material preferably differs by less than 50%, particularly preferably by less than 20% from the refractive index of the resin system.

For the same symmetry class (polar or nonpolar, for example), the wavelength or frequency of the electromagnetic radiation generated in the optical material usually does not depend on the material, the fibres or the nanoparticles, for example. In principle, any type of optical material can be used.

Very cost-effective dielectric nanoparticles such as TiO₂ can be used, for example. The use of such inexpensive nanoparticles does not significantly increase the total cost.

Presumably, the wettability of the optical material by the resin system strongly depends on the surface tension of the resin system. Hence, it is especially preferred if the surface tension of the resin system ranges from 10 to 40 mN/m. Usually, the surface tension of resins in the liquid state corresponds to the surface tension of resins in the solid state which is calculated by means of the advancing angle. For instance, UP resins typically have a surface tension in a range from 30 to 40 mN/m (Kopczynska et. al., Oberflachenspannung von Kunststoffen—Messmethoden am LKT, reprint, Chair of Plastics Technology, University of Erlangen-Nuremberg, 2007, 2010 revised, section 4.3). For example, the surface tension of the liquid resin system can be determined by the Wilhelmy plate method as described there.

Preferably, the optical material is dispersible with the resin system.

Preferably, the surface of the optical material can be functionalised. Only for very small particles (having diameters smaller than 20 nm, for example) the surface effect can become significant. Hence, preferably a chemical and/or mechanical and/or optical adjustment of the optical material to the environment can be achieved without affecting the process as a whole. This allows to improve the wettability and the dispersibility, for example.

Initiator

The resin system according to the invention contains at least one initiator, preferably in an amount ranging from 0.01 to 5% by weight, particularly preferred ranging from 0.05 to 1% by weight. Thanks to the new technology, significantly less initiator is required. Preferably, it is a photoinitiator.

Preferably, the initiator has a transmission of greater than 95% at the wavelength of the irradiated electromagnetic radiation.

Preferably, the bands of the largest, the second largest and/or the third largest transmission minimum of the initiator do not correspond to the wavelength of the irradiated electromagnetic radiation.

Preferably, the initiator has at least one transmission minimum in a wavelength range from 3 to 60% of the wavelength of the coherent electromagnetic radiation.

Preferably, at least one initiator has a transmission minimum at a wavelength that differs by a maximum of 100 nm, particularly preferably by a maximum or 50 nm, from ½ or ⅓ or ¼ of the wavelength of the irradiating coherent electromagnetic radiation. Preferably, this transmission minimum is the largest, second largest or third largest transmission minimum of the initiator.

Preferably, the initiator is not encapsulated. This way it can be effective immediately and result in a homogeneous curing. Preferably, the initiator is activated by electromagnetic radiation, especially light.

The harmonics allow the optical material to simultaneously generate several wavelengths or frequencies over the entire spectral region in which the material is transmitting. Hence, a mixture of several initiators can also be used. It can therefore be preferred that the resin system contain a mixture of several initiators.

Preferably, initiators with at least one transmission minimum in the range from 200 to 10000 nm, especially preferably in a range from 300 to 700 nm, very particularly preferably in a range from 380 to 450 nm are used.

Preferably, the optical absorption of the initiator at the wavelength of the irradiating electromagnetic radiation is less than 10%, very particularly preferably less than 5%, most preferably less than 2%. The measurement of the absorption or transmission can be carried out in the usual way by means of a spectrometer, such as a UV spectrometer or an infrared spectrometer, for example. This allows the irradiating electromagnetic radiation to penetrate particularly deep into the resin system and to cure the resin system particularly homogeneously, fast and completely.

Resin System Preferably, the resin system according to the invention is a resin system for curing liners. For example, the resin system can be a resin system of unsaturated polyester, vinyl ester or an epoxide resin system.

Preferably, the resin system according to the invention can also contain thermal initiators such as, for example, azo compounds or peroxides. Preferably, however, benzoyl peroxide is not used as a thermal initiator since it is dangerous for the environment.

Preferably, the resin system contains clay particles in an amount of at most 1% by weight, more preferably no clay particles.

Preferably, the resin system contains natural fibres in an amount of at most 1% by weight, more preferably no natural fibres.

Additional fillers (aluminium hydroxide or calcium carbonate, for example) may also be included.

### FURTHER EMBODIMENTS

In another embodiment the object of the invention is achieved by an uncured liner impregnated with a resin system according to the invention.

In another embodiment the object of the invention is achieved by a method for curing a liner wherein a liner is cured by means of coherent electromagnetic radiation.

The preferred embodiments described above with respect to the previous embodiments apply accordingly to this method according to the invention.

Preferably, the coherent electromagnetic radiation is hence laser light.

Preferably, the resin system comprises an initiator having a transmission of greater than 95% at the wavelength of the irradiated electromagnetic radiation.

Preferably, laser light with an intensity in a range from 1010 to 1016 W/m² is used in the method according to the invention. The efficiency of the generation of light by frequency conversion can be controlled by the intensity, for example. As a rule, a high laser power and/or wavelength are not sufficient to generate a harmonic. Usually, the intensity is defined as power per unit area, that is, watts per square metre, that is, W/m².

Preferably, pulsed laser light is used since it allows to generate very high light intensities. The pulse length is preferably in a range from 10 to 150 femtoseconds. This increases the intensity, for example, and the resin cures faster.

The coherence length can preferably be in the range from the median of the particle diameter of the optical material −10% to the median of the particle diameter of the optical material +10%.

Preferably, as previously described, the wavelength of the coherent electromagnetic radiation is in a wavelength range from 200 to 20000 nm, especially preferably in a wavelength range from 300 to 5000 nm, particularly preferably in a wavelength range from 700 to 2000 nm, most preferably in a range from 800 to 1600 nm.

The coherent electromagnetic radiation can preferably have a wavelength in a range from 760 to 1600 nm, that is, be in the (near) infrared. Lasers in this spectral region are very cost-effective and efficient and have a high penetration depth. At these wavelengths a typical resin system has a high transmission.

Preferably, the optical material such as the dielectric nanoparticles is useful in the method for several reasons. A later use is possible if the illumination proceeds in several steps and/or the illumination has to be repeated due to an incorrect reaction.

Preferably, a liner according to the invention and/or a resin system according to the invention are used in the method.

In another embodiment, the object of the invention is achieved by the use of coherent electromagnetic radiation for curing a liner. Preferably, a not encapsulated initiator is activated.

Preferably, the initiator has a transmission of greater than 95% at the wavelength of the irradiated electromagnetic radiation.

In another embodiment, the object of the invention is achieved by a method for curing a resin system
a. wherein a coherent electromagnetic radiation with a wavelength in a wavelength range from 200 to 20000 nm is irradiated into the resin system,
b. wherein the resin system contains at least one optical material and at least one initiator,
c. wherein the optical material emits at least light with a wavelength of ½, ⅓ and/or ¼ of the wavelength of the coherent electromagnetic radiation for activating the initiator and curing the resin system.

Preferably, as previously described, the initiator has at least one transmission minimum for electromagnetic radiation in a wavelength range from 3 to 60% of the wavelength of the irradiated electromagnetic radiation.

Preferably, a resin system according to the invention is used.

Preferably, the coherent electromagnetic radiation is generated by a pulsed laser having in particular a pulse length in a range from 10 to 150 femtoseconds. This increases the intensity, for example, and the resin cures faster.

Within the scope of the invention the preferred embodiments described for embodiments should also be considered to be preferred embodiments of the other embodiments as long as this is considered as reasonable by specialists in this field.

### EXEMPLARY EMBODIMENT

A commercially available resin impregnated liner as described in EP2573442A1, for example, was used. However, 5% by weight of barium titanate nanocrystals (Merck company) with a median diameter of 300 nm were added to the resin system described there. Additionally, the resin system contained 3% by weight of Irgacure 819 as a photoinitiator. During the rehabilitation, the liner was inserted into the pipe to be rehabilitated and then inflated with compressed air. Subsequently, the liner was irradiated with a Ti3+:Al₂O₃ laser oscillator with a regenerative amplifier and a downstream optical parametric oscillator (OPO, Astrella of the Coherent Inc. company, HE version with 6 mJ; repetition rate 1 kHz; mean power at 1 W, pulse peak intensity: 3×10¹⁵ W/m², pulse duration 40 femtoseconds) and thus cured. The wavelength at the OPO output was 840 nm. Due to the glass fibres and the nanoparticles in the liner, light of the second and third harmonics (½ of the irradiated wavelength=420 nm; 1/3 of the irradiated wavelength=about 280 nm) was emitted. Thus, the photoinitiator could be activated, and the resin could be cured.

The features of the invention disclosed in the present description and in the claims both individually and in any combination may be essential to the realisation of the various embodiments of the invention. The invention is not limited to the described embodiments. It may be varied to the extent as falls into the scope of the invention, taking into account the knowledge of one skilled in the art.

1. A resin system for curing by means of coherent electromagnetic radiation comprising at least one optical material and at least one initiator.

2. The resin system according to claim 1, wherein the initiator has a transmission of greater than 95% at the wavelength of the irradiated electromagnetic radiation.

3. The resin system according to claim 1, wherein the refractive index of the optical material differs from the refractive index of the resin system by less than 50%.

4. The resin system according to claim 1, wherein the wavelength of the coherent electromagnetic radiation is in a range from 200 to 20000 nm, especially in a range from 800 to 1600 nm.

5. The resin system according to claim 1, wherein the optical material is dielectric nanoparticles and/or dielectric fibres.

6. The resin system according to claim 1, wherein the at least one initiator is contained in an amount in a range from 0.01 to 5% by weight, especially in a range from 0.05 to 1% by weight.

7. The resin system according to claim 1, wherein the initiator is not encapsulated and in particular activated by electromagnetic radiation.

8. An uncured liner impregnated with the resin system according to claim 1.

9. A method for curing a liner comprising irradiating a coherent electromagnetic radiation.

10. A method for curing a liner comprising irradiating a coherent electromagnetic radiation, wherein the liner is the uncured liner according to claim 8.

11. The method according to claim 9, wherein the resin system comprises an initiator having a transmission of greater than 95% at the wavelength of the irradiated electromagnetic radiation.

12. (canceled)

13. (canceled)

14. A method for curing a resin system, comprising
irradiating a coherent electromagnetic radiation with a wavelength in a wavelength range from 200 to 20000 nm into the resin system,
wherein the resin system contains at least one optical material and at least one initiator, and
wherein the optical material emits at least electromagnetic radiation with a wavelength of ½, ⅓ and/or ¼ of the wavelength of the coherent electromagnetic radiation for activating the initiator and curing the resin system.

15. The method according to claim 14, wherein a resin system comprising at least one optical material and at least one initiator and a liner is impregnated with the resin system.

16. The method according to claim 14, wherein the coherent electromagnetic radiation is generated by a pulsed laser having in particular a pulse length in a range from 10 to 150 femtoseconds.
